(19) United States
(12) Patent Application Publication
(10) Pub. No.: US 2014/0254956 A1
(43) Pub. Date: Sep. 11, 2014

(54) WATER-RESISTANT CONTAINER

(71) Applicant: ROC GEAR, INC., Commerce, GA (US)

(72) Inventor: John J. BUELL, III, Commerce, GA (US)

(73) Assignee: ROC GEAR, INC., Commerce, GA (US)

(21) Appl. No.: 13/790,100

(22) Filed: Mar. 8, 2013

(51) Int. Cl. B65D 33/00; B31B 49/00

(52) U.S. Cl. CPC B65D 33/00; B31B 49/00
USPC 383/64; 190/113; 383/88; 383/89; 493/267

(57) ABSTRACT

A waterproof bag forming an enclosure, and having an opening with a waterproof horizontal zipper closure mechanism sealingly attached therein. A rollable top portion of the enclosure can be rolled down to cover the opening and closure mechanism to reduce pressure exerted on the zipper during submersion, allowing the enclosure to safely reach greater depths while maintaining water resistance. Methods of constructing and using a waterproof bag are also disclosed.

### TECHNICAL FIELD

The present invention relates generally to the field of waterproof or water resistant containers and enclosures, and more particularly to a waterproof bag apparatus having an increased depth rating, and to methods of constructing and using the same.

### BACKGROUND

Waterproof bags are commonly used recreationally in kayaking, boating, rafting, hiking, camping, and various other activities. Other users, including the military, have specialized needs for flexible waterproof enclosures as well. While it may be most common for a waterproof bag enclosure to maintain its security to depths no greater than 2 or 3 feet, it is often desirable that a waterproof bag enclosure have the capability to be submerged to various depths, for example up to or over 10 feet. Such depth ratings may be specified, for example, in kayaking, scuba diving or military applications.

Water-resistant containers typically include an opening in the container body for accessing the container's contents, and a closure such as a waterproof zipper for opening to access the container's interior and closing to seal the container. There are many types of waterproof zippers currently on the market, but the most waterproof (submersible to the greatest depths) typically incorporate a “vertical” style closure, having closure elements extending along confronting interior surfaces adjacent an opening at the top of a bag, in a similar format to a “Ziploc®” bag seal. While this vertical style zipper may be waterproof to great depths, it is generally not easy to open or close. FIGS. 1 and 2 show an example form of a container having a vertical zipper.

The more user-friendly zippers with a traditional “horizontal” attachment (available commercially from companies such as T-Zip®, YKK®, or SubZipper™), and most often using a slider to easily open and close, are typically more limited in terms of the pressure they can resist. This lower pressure resistance of the current horizontal zippers means that when incorporated into a fully waterproof bag, the more user-friendly zipper format typically cannot handle submersion to depths much greater than 5 or 10 feet. FIG. 3 shows an example form of a horizontal zipper. As noted, horizontal zippers are generally considered more user-friendly than vertical zippers, but vertical zippers typically provide greater water resistance and allow a higher depth rating for waterproof enclosures or containers having vertical zipper closures.

A common short-coming of waterproof zippers (vertical or horizontal) is that they generally must be kept clean in order to maintain their maximum waterproof capabilities. While it may appear on the surface that the zipper is still functioning properly with a little dirt or debris in the closure elements, once put to the test, a small amount of dirt or debris can allow a small amount of water to circumvent the previously water-tight zipper closure. This could be detrimental if the enclosure contains any personal electronic items.

There are many roll-top bags (commonly referred to as ‘dry bags’), roll-top duffel bags, and even roll-top backpacks currently on the market. These are typically RF (Radio Frequency) welded from PVC (poly-vinyl chloride) or Polyurethane in order to maintain a water-tight body. And the top opening is rolled down on itself to create a semi-waterproof seal. This seal is efficient for top-down watering applications, but cannot handle prolonged submersion any more than a few seconds, as water will eventually find its way around the rolls, and into the bag.

Thus it can be seen that needs exist for improved waterproof or water-resistant containers. It is to the provision of an improved waterproof or water-resistant container meeting these and other needs that the present invention is primarily directed.

### SUMMARY

In example embodiments, the present invention provides a waterproof bag or flexible container that is capable of being submerged under water, for example to depths of at least 10 feet, and retaining a high degree of water resistance or waterproof integrity to protect the contents of the container. In example embodiments, the water proof bag generally comprises an impermeable bag with an opening, a reusable horizontal waterproof zipper closure mechanism for reclosably sealing the opening, a rollable top portion of the bag, and interengagement or retention features for holding the rollable top portion of the bag in a rolled configuration with the horizontal zipper closure held within the rolled top, thereby retaining the integrity of the closure mechanism in its closed and waterproof state. Rolling the rollable top portion of the bag over and around the zipper prevents water pressure from working to pull the interengaging zipper closure elements apart when the bag is submerged, thereby increasing the depth rating of the bag over that of typical bags utilizing horizontal zippers, while maintaining the more user-friendly operation of a horizontal zipper as compared to vertical zippers.

In one aspect, the present invention relates to a waterproof bag. The waterproof bag preferably includes an impermeable material forming an enclosure wherein an internal contained space is defined therein, and having an opening for access to the contained space. The enclosure preferably has a rollable top portion configurable in an unrolled state exposing the opening, and a rolled state enclosing the opening therein. The waterproof bag preferably also includes a closure mechanism sealingly secured to the impermeable material around the opening, and movable between an open position allowing access through the opening and a closed position forming a waterproof seal preventing passage through the opening. The closure mechanism is preferably a waterproof horizontal zipper. The waterproof bag preferably also includes interengagement couplings for retaining the rollable top portion in the rolled state.

In another aspect, the invention relates to a highly water-resistant or waterproof container including an outer containment body formed of a water-impermeable material and bounding a contained space defined internally therein. The containment body preferably has a rollable portion and an opening formed through the water-impermeable material in the rollable portion. A waterproof closure such as a waterproof horizontal zipper is preferably provided, and operable between an open position allowing access through the opening and into the contained space and a closed position sealing the opening against water passage. The rollable portion is configurable in an unrolled state exposing the opening and the closure, and in a rolled state enclosing the opening and the closure internally therein.

In still another aspect, the invention relates to a method of constructing a waterproof bag. The method preferably includes the step of forming an enclosure defining a contained space and having a rollable top portion, and having an opening formed in the rollable top portion for access to the contained space. The method preferably also includes the step of sealingly attaching a waterproof closure mechanism such as a horizontal waterproof zipper within the opening, the closure mechanism being operable between an open position allowing access to the contained space and a closed position preventing passage through the opening. The method preferably also includes attaching retention means to the enclosure for retaining the rollable top portion in a rolled configuration with the opening and closure mechanism shielded within the rolled top portion.

In another aspect, the invention relates to a method of storing a contained item using a waterproof bag. The method preferably includes providing an impermeable bag having a closure mechanism such as a horizontal waterproof zipper, wherein an opening permits access for placement of the contained item therein. The method preferably also includes closing the closure mechanism to form a waterproof seal preventing passage through the opening. The method preferably also includes rolling a rollable portion of the bag to cover the opening and the closure mechanism, and securing the rollable portion to maintain a rolled configuration.

In another aspect, the invention relates to a waterproof bag including an impermeable material forming an enclosure with an internal storage chamber defined therein; a waterproof horizontal zipper or other water resistant closure mechanism sealingly attached to the impermeable material of the enclosure, the closure mechanism capable of providing access to the internal cavity in an open position and forming a waterproof seal in a closed position, and roll-top interengagement features secured to portions of the impermeable material allowing a top portion of the bag to be rolled over the closure mechanism and retained in the rolled configuration.

In yet another aspect, the present invention relates to a waterproof carrying case. The waterproof carrying case includes an impermeable material forming an enclosure, a closure mechanism such as a horizontal waterproof zipper sealingly attached to the impermeable material, and interengagement features secured to portions of the impermeable material to retain a rolled portion of the case over the closure mechanism. The closure mechanism is capable of providing access to an internal chamber of the case in the open position and forms a waterproof seal in the closed position.

In another aspect, the invention relates to a method for constructing a waterproof container. The method includes providing a water-resistant shell defining a storage area or reservoir therein; sealingly attaching a reclosable waterproof horizontal zipper closure mechanism around an opening in the shell, and providing a portion of the shell that can be rolled to cover the closure mechanism.

In another aspect, the invention relates to a method of using a water-resistant container to protect a contained item from water damage. The method includes providing a liquid impermeable bag comprising a waterproof horizontal zipper closure mechanism wherein an opening permits access to an internal chamber thereof; placing a contained item in the internal chamber, closing the closure mechanism to seal the opening; rolling over a portion of the container to cover the closure mechanism internally within a rolled portion thereof; and securing the rolled portion to maintain a closed configuration.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a vertical zipper closure profile.

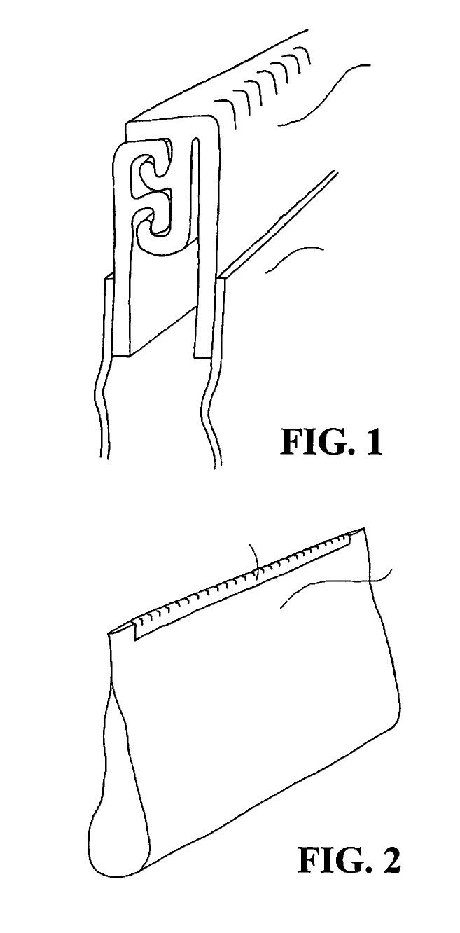

FIG. 2 shows a bag having a vertical zipper closure.

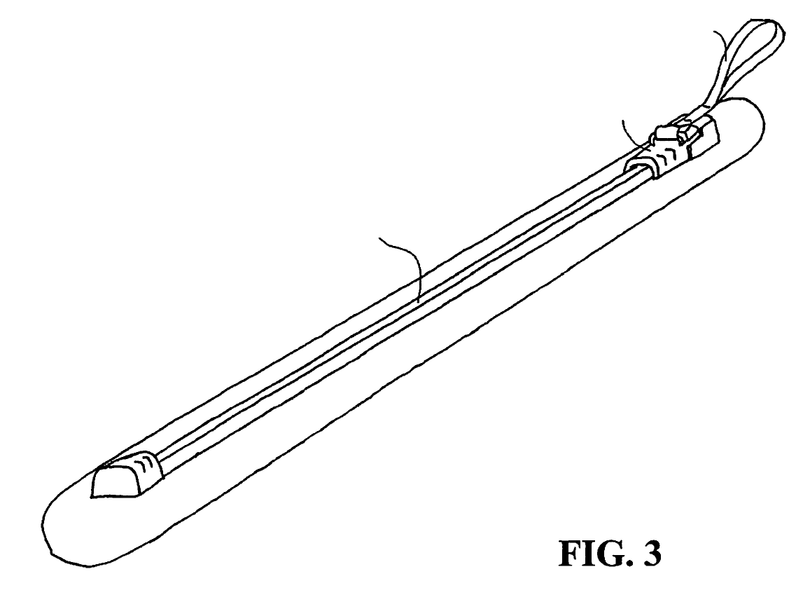

FIG. 3 shows a horizontal zipper closure

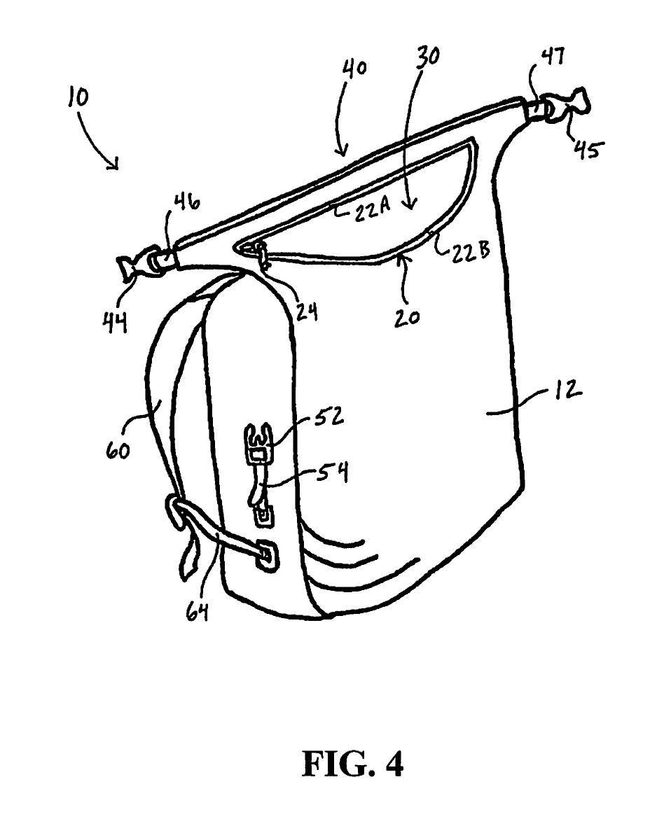

FIG. 4 is a perspective view of a waterproof bag according to a first example embodiment of the present invention, with a closure mechanism in the open position and with a roll top unrolled for access to the opening and closure mechanism.

FIG. 5 is a perspective view of the waterproof bag of FIG. 1, with the closure mechanism in the closed position.

FIG. 6 is a perspective view of the waterproof bag of FIG. 1, with the closure mechanism in the closed position and the roll top rolled over the closure and attached to retain the roll top in place.

FIG. 7 shows a front perspective view of a waterproof bag according to another example embodiment of the present invention.

FIG. 8A shows a perspective view of a waterproof bag according to another example embodiment of the present invention.

FIG. 8B shows a partial perspective close-up view of the roll top portion of the waterproof bag of FIG. 5A.

FIGS. 9-13 show a sequence of steps of a method of fabrication of a waterproof bag according to an example form of the invention

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Generally described, the present invention relates to a waterproof or highly water-resistant bag or other container, for example a bag that is capable of being submerged under water to depths of at least about 3 feet or more, and more preferably to depths of at least about 10 feet or more, without any significant leakage of water into the interior containment volume of the bag. In example embodiments, the water proof bag generally comprises an impermeable bag, a closure mechanism, a roll top, and interengagement features to retain the roll top in a closed configuration. The invention further relates to a fabrication process for forming such a bag or container, and a method of use of such a bag or container to protect a contained item sealed therein from water contact and potential water damage resulting therefrom.

In example forms, the impermeable bag defines an internal cavity or containment space bounded by an outer containment formed of a flexible water-impermeable material, an opening through the outer containment for accessing the containment space, and a reclosable closure mechanism for sealing the opening to prevent ingress of water into the containment space. Preferably, the closure mechanism is easily movable between a closed position and an open position by moderate or light hand force applied by a user. The opening is preferably formed near a top section of the bag, and the bag includes a roll top portion above the opening, which can be rolled down to cover the opening and the closure mechanism and secured in place in the rolled position. To seal the waterproof bag, the closure mechanism is closed (e.g., sealed) and the roll top portion is rolled down and secured in the closed configuration by one or more interengagement features.

In another example form, the present invention relates to a waterproof container such as, for example, a dry bag, a carrying case, a duffle bag, a backpack, or other flexible or partially flexible enclosure product. The waterproof carrying case comprises an outer shell of water-impermeable material forming an enclosure, an opening through the impermeable material, a closure mechanism sealed with the impermeable material to alternatively allow access through or seal the opening, a roll top portion of flexible material that can be rolled up to expose the closure mechanism for access to the opening or rolled down to cover the closure mechanism, and interengagement features such as straps and/or clips adapted to secure the roll top portion in the rolled-down configuration. The enclosure defines an internal cavity therein for containment of one or more contained items. Preferably, the closure mechanism is capable of providing access to the internal cavity in its open position and forms a waterproof seal in its closed position.

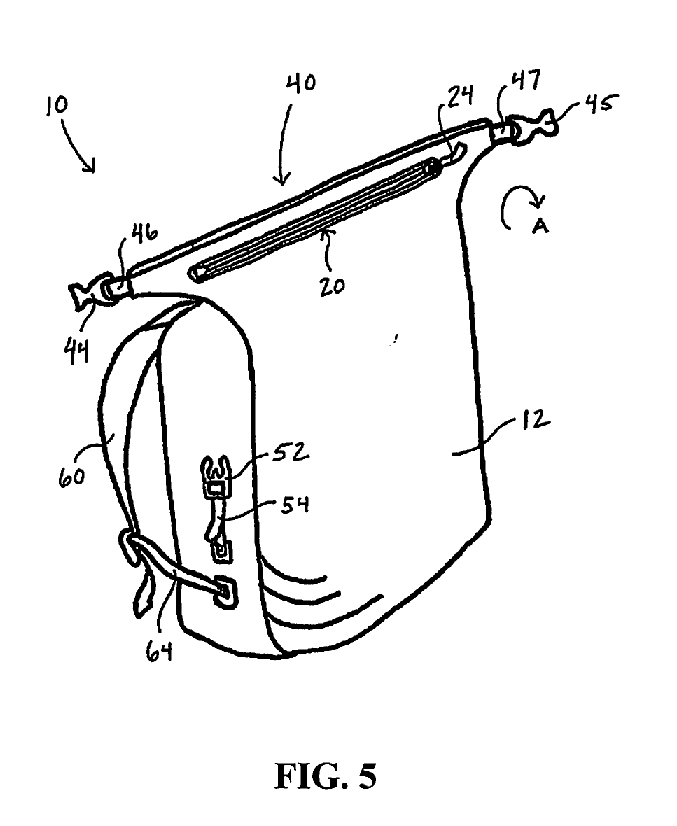

With reference now to the drawing figures, wherein like reference numbers represent corresponding parts throughout the several views, FIGS. 4-6 show a waterproof bag 10 according to an example embodiment of the present invention. The waterproof bag 10 is generally forms a body 12 that is constructed from an impermeable material to define an internal cavity. An opening is formed in a front panel of the bag 10 for access to the internal cavity of the bag. The opening is preferably positioned proximal to or adjacent the top of the bag 10, preferably in the range of about 0.5″ to 6″ from the top. Placing the opening in this location will allow the zipper (including horizontal flanges) to begin attachment somewhere from 0″ to 5.5″ from the top. At a minimum, the opening is preferably in the top 20% of the enclosure, so that the zipper can be captured in the rolls by rolling down the top portion anywhere from 2-5 times. In the depicted embodiment, the opening is a horizontal slit, generally parallel to the top edge of the bag 10, and extending across at least a portion of the width of the bag, but in alternate embodiments may be otherwise oriented or positioned. In example forms, the opening is at least about 6″ wide, and preferably about 12″ to 24″ wide, so that the opening encompasses about 50% to about 95% of the width of the overall enclosure, in example embodiments.

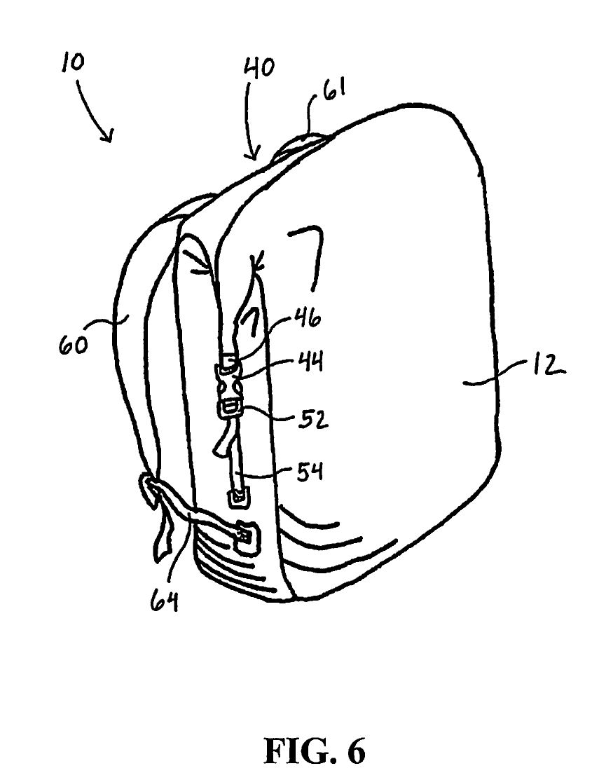

A closure mechanism 20 is sealed with the impermeable material and is operable to provide access to the internal cavity. For example, when the closure mechanism 20 is in the open position, an opening 30 is formed to allow the internal cavity to be accessible (see FIG. 4), and when the closure mechanism 20 is closed (see FIG. 5), a waterproof seal is formed. The closure mechanism 20 preferably comprises a horizontal waterproof zipper having first and second interengaging closure strips 22A, 22B, a slider 24 having a pull tab for engaging and disengaging the closure strips with one another to open and close the opening, and attachment flanges for sealed attachment of the zipper to the material of the bag along the sides of the opening. Preferably, the closure mechanism 20 is sealingly attached with the impermeable material of the bag, for example, by RF (radio frequency) welding, permanent glue bond, waterproof seam tape or other waterproof attachment means.

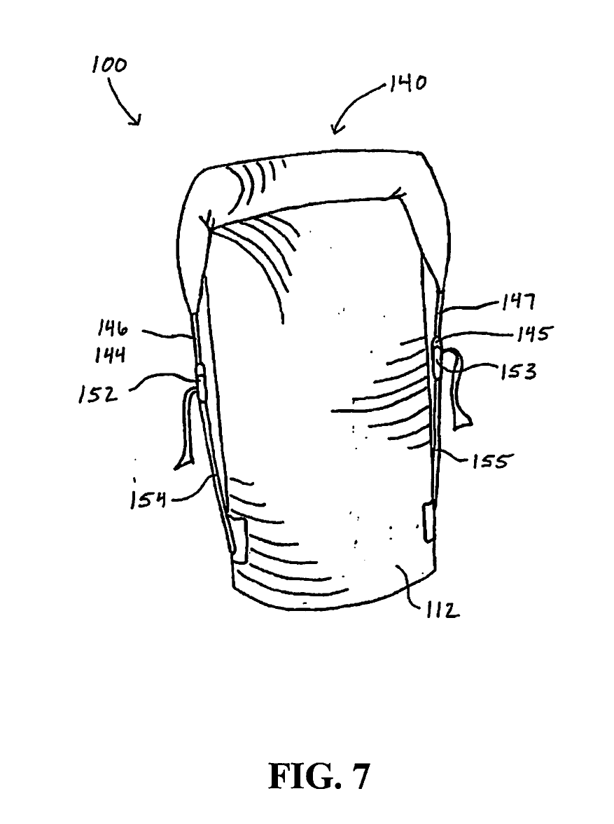

A roll top portion 40 is preferably formed as a top section of the waterproof bag 10, and includes the opening 30 and closure 20. The roll top 40 allows a portion of the waterproof bag 10 to be rolled down from the top edge and secured in a closed configuration (FIG. 6) covering the opening 30 and closure 20 internally within the rolled layers of material. For example, from the unrolled configuration of FIG. 5, the roll top 40 is generally rolled or folded at least two times in the direction of arrow A so that the closure mechanism 20 is positioned within the roll. One or more upper interengagement elements 44, 45 secure to cooperating lower interengagement elements 52, 53 to maintain the closed configuration (FIG. 6). The interengagement features 44, 45, 52, 53 can comprise, for example, plastic clips or buckles that are secured to the bag 10 with straps or webbing extending from each side of the top and sides of the bag. Optionally, other forms of interengagement features such as snaps or hook-and-loop material may be utilized to retain the rolled top in a rolled down configuration.

Advantageously, as the closure mechanism 20 is positioned within the roll when the roll top 40 is rolled or folded, depth pressure from submersion in water does not work to pull the zipper apart. Rolling the top down over the zipper assists in resisting horizontal pressure on the zipper. Horizontal zippers are typically more susceptible to pressure than vertical zippers, but by positioning the zipper within the rolled top portion, pressure on the bag due to depth of submersion does not act to pull the closure elements of the zipper apart as might otherwise occur. Also, the rolled top shields the closure mechanism from external dirt and debris when in use, which might otherwise cause an improper seal of the closure mechanism 20.

Optionally, a pair of shoulder straps 60, 61 may be provided along a portion of the waterproof bag to facilitate carrying the same, for example, in the form of a backpack. The shoulder straps 60, 61 may be provided with adjustable portions 64, 65 to accommodate users of various sizes. Also optionally, one or more external pockets, pouches, daisy-chain anchors, straps, clips, couplings or other features may be provided on the container 10 for different applications as desired.

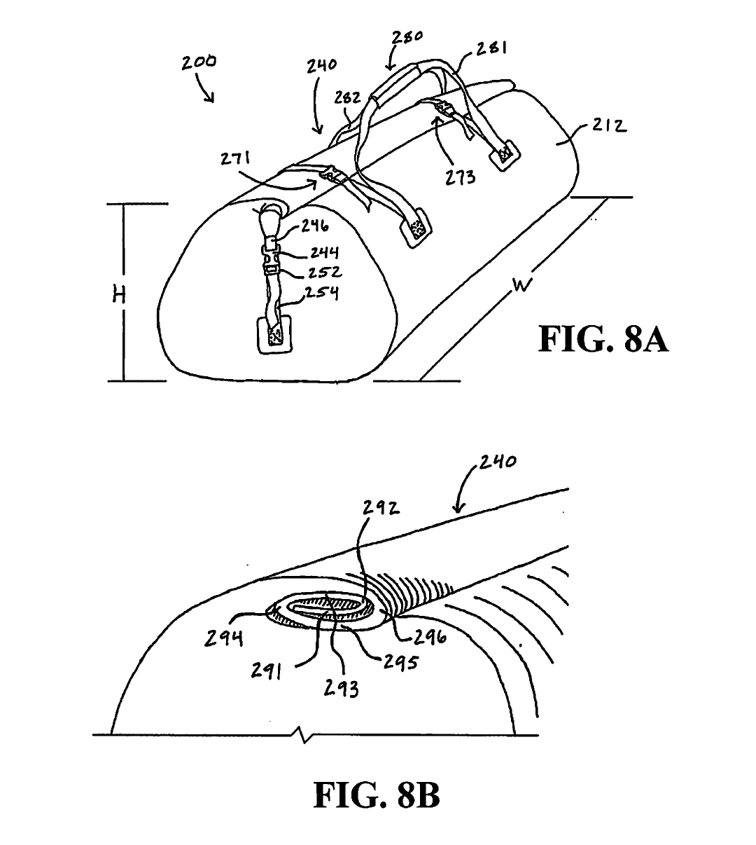

FIG. 7 shows a waterproof bag 100 according to another example embodiment of the present invention. As depicted, the waterproof bag 100 is a generally rectangular or tubular shaped enclosure or shell having a front, a back, and closed and sealed bottom, side and top edges bounding an enclosed internal containment space, and a rollable top 140. An opening having a waterproof closure mechanism such as a horizontal zipper is provided through the front panel of the rollable top portion 140 for access to the internal containment space. Interengagement features 144, 145, 152, 153 such as straps and clips are provided for retaining the top portion in a rolled configuration enclosing the closure mechanism internally with the rolled top 140.

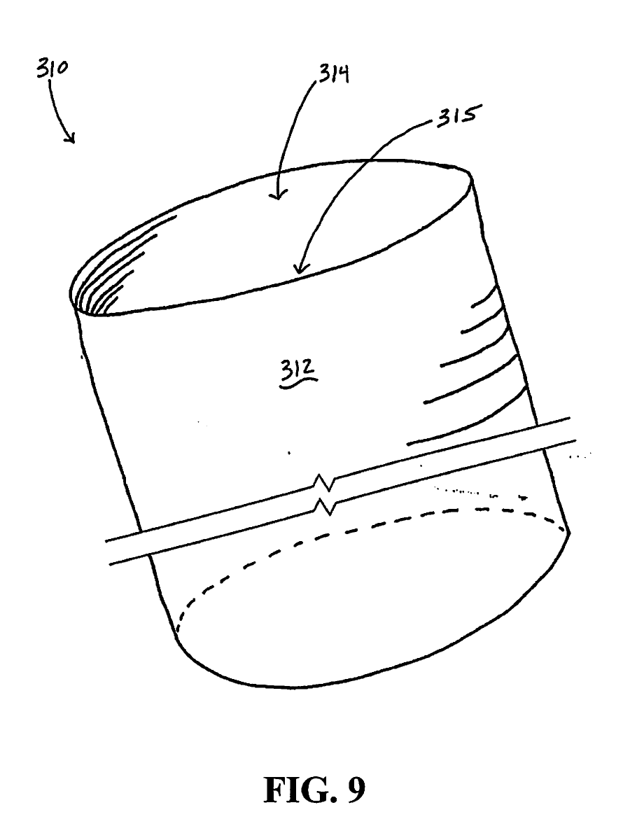

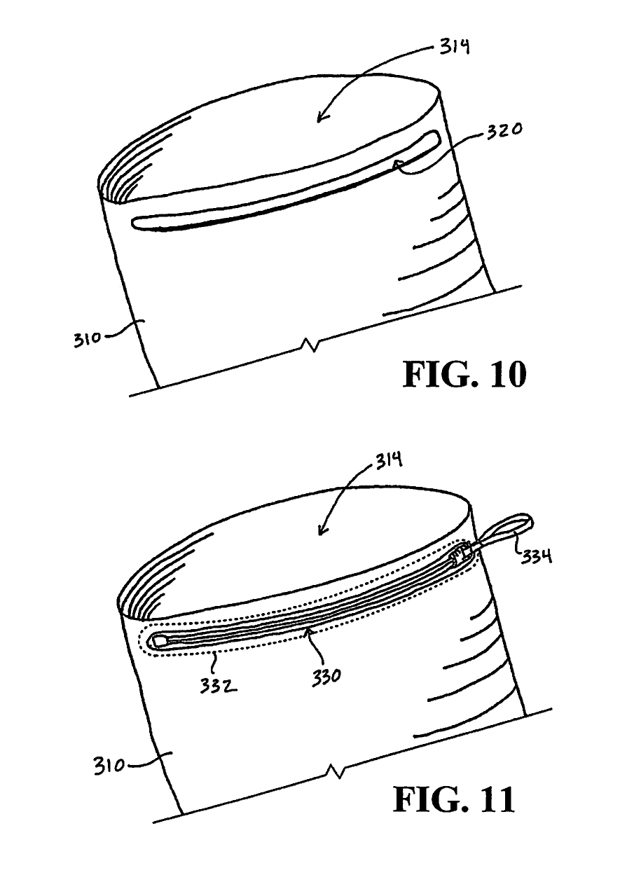

FIGS. 8A-8B show a waterproof bag 200 according to another example embodiment of the present invention. In this embodiment, the waterproof bag 200 is generally in the form of a duffel bag. As depicted in FIG. 8A, the body 212 forming the impermeable material generally has a width W that is greater than its height H. As similarly depicted in the example embodiment of FIG. 7, the waterproof bag 200 is in the closed configuration wherein the roll top 240 is rolled up and the interengagement features 244, 245, 252, 253 (portions unshown) are engaged to secure the top in the rolled configuration. The closure mechanism is in the closed position and enclosed internally within the rolled top 140. Optionally, one or more additional straps, interengagement features, handles, etc. may be provided as desired. For example, interengagement features 271, 273 are provided to further secure the roll top 240, and a carrying handle 280 (formed with two straps 281, 282) is provided to facilitate carrying the waterproof duffle bag 200.

FIG. 8B shows further details of an example form of the roll top 240 of a bag according to the present invention, in the closed or rolled-down configuration. As depicted, the closed configuration generally comprises a first folded portion 291, a first fold 292, a second folded portion 293, a second fold 294, a third folded portion 295, and a third fold 296. The closure mechanism is enclosed within the folds or rolls of the roll top portion 240 of the bag when closed, to provide an improved sealing arrangement.

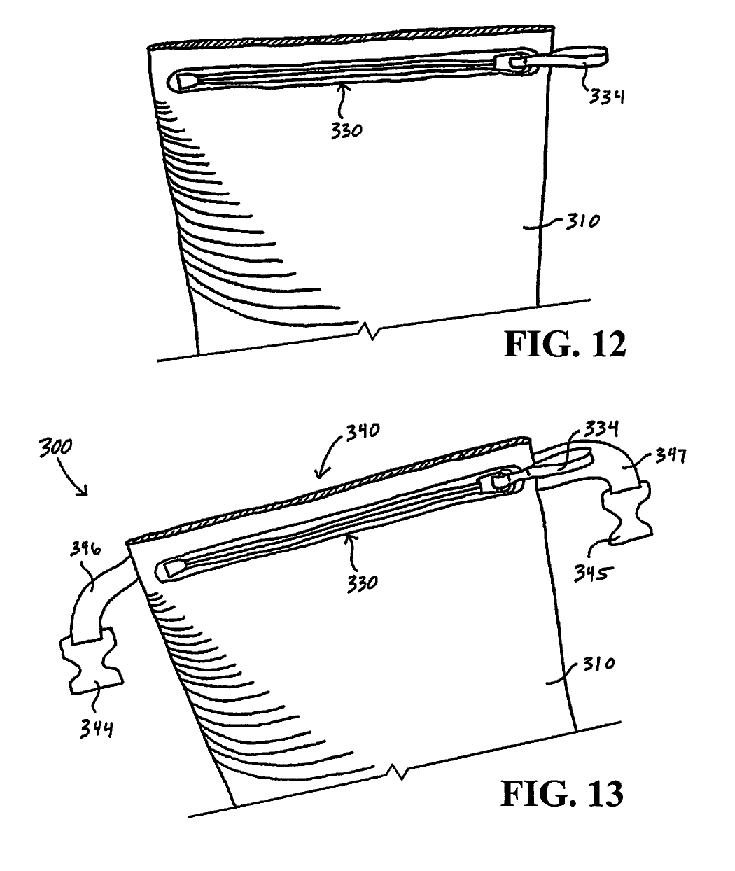

FIGS. 9-13 show a sequence of steps of a method of making a waterproof bag 300 according to an example form of the present invention. The method generally comprises providing an impermeable material 312; forming the impermeable material 312 to form a bag 310, the bag 310 generally having a first opening 314 defining a reservoir 315 therein (FIG. 9); forming a second opening 320 in the impermeable material, the second opening 320 generally offset from the first opening 314 (FIG. 10); sealing a waterproof closure mechanism 330 to the second opening 320 (FIG. 11); sealing the first opening 314 to form an internal cavity or chamber therein (FIG. 12); and attaching interengagement coupling elements 344, 345, 352, 353 (partially unshown) thereon (FIG. 13). Optionally, the steps of the method may be performed in a different order; for example, it may be desired to form the second opening 320 within the impermeable material 312 prior to forming the bag 310, or it may be desired to seal the first opening 314 prior to sealing the waterproof closure mechanism 330 to the second opening 320. As depicted in FIG. 11, the phantom line 332 represents an attachment flange or flap portion of the closure mechanism 330 that is sealed to the impermeable material 312 of the bag 310, for example, by RF (radio frequency) welding, permanent glue bond, waterproof seam tape, or other attachment means.

The present invention also includes methods of using a waterproof bag. In example embodiments, the method generally comprises providing an impermeable bag having an opening with a closure mechanism; closing the closure mechanism such that the same forms a seal preventing water passage through the opening; rolling over a portion of the bag at least one time such that the closure mechanism is positioned within the roll; and securing the roll to the bag to maintain a closed configuration.

While the invention has been described with reference to preferred and example embodiments, it will be understood by those skilled in the art that a variety of modifications, additions and deletions are within the scope of the invention, as defined by the following claims.

What is claimed is:

1. A waterproof bag comprising:
an impermeable material forming a waterproof enclosure wherein an internal contained space is defined therein, and having an opening for access to the contained space, and a rollable top portion configurable in an unrolled state exposing the opening and a rolled state enclosing the opening therein;
a horizontal waterproof zipper closure mechanism sealingly secured to the impermeable material around the opening, and movable between an open position allowing access through the opening and a closed position forming a waterproof seal preventing passage through the opening; and
interengagement couplings for retaining the rollable top portion in the rolled state;
wherein rolling the rollable top portion over the opening increases the resistance of the closure mechanism to separation resulting from pressure due to submersion at a depth.

2. The waterproof bag of claim 1, wherein the waterproof zipper has attachment flanges sealed to the impermeable material around the opening.

3. The waterproof bag of claim 1, wherein the closure mechanism is sealed to the impermeable material by radio frequency welding, permanent glue bond, waterproof seam tape, heat welding, hot air welding and/or other waterproof attachment means.

4. The waterproof bag of claim 1, wherein the closure mechanism is sealed to the impermeable material by radio frequency welding.

5. The waterproof bag of claim 1, comprising a duffel bag.

6. The waterproof bag of claim 1, comprising a roll-top dry bag.

7. The waterproof bag of claim 1, comprising a backpack.

8. A highly water-resistant or waterproof container comprising:
an outer containment body formed of a water-impermeable material and bounding a contained space defined internally therein, the containment body having a rollable portion and an opening formed through the water-impermeable material in the rollable portion; and
a horizontal waterproof closure operable between an open position allowing access through the opening and into the contained space and a closed position sealing the opening against water passage;
wherein the rollable portion is configurable in an unrolled state exposing the opening and the closure, and in a rolled state enclosing the opening and the closure internally therein.

9. The highly water-resistant or waterproof container of claim 8, wherein the waterproof closure comprises a horizontal waterproof zipper.

10. The highly water-resistant or waterproof container of claim 8, further comprising at least one retention strap, buckle, snap, and/or other retention means attachable to the rollable portion to retain the rollable portion in its rolled state.

11. The highly water-resistant or waterproof container of claim 8, wherein the outer containment body is formed by a water-tight process selected from radio frequency welding, permanent glue bond, waterproof seam tape, heat welding, hot air welding, and/or combinations thereof.

12. The highly water-resistant or waterproof container of claim 8, wherein the outer containment body is formed by a water-tight process selected from radio frequency welding.

13. The highly water-resistant or waterproof container of claim 8, wherein the waterproof closure is sealingly attached to the outer containment body by a water-tight attachment selected from radio frequency welding, permanent glue bond, waterproof seam tape, or combinations thereof.

14. The highly water-resistant or waterproof container of claim 8, wherein the outer containment body comprises a duffel bag.

15. The highly water-resistant or waterproof container of claim 8, wherein the outer containment body comprises a roll-top dry bag.

16. The highly water-resistant or waterproof container of claim 8, wherein the outer containment body comprises a backpack.

17. A method of constructing a waterproof bag, the method comprising:
forming an enclosure defining a contained space and having a rollable top portion, and having an opening formed in the rollable top portion for access to the contained space;
sealingly attaching a waterproof horizontal zipper closure mechanism within the opening, the closure mechanism being operable between an open position allowing access to the contained space and a closed position preventing passage through the opening; and
attaching retention means to the enclosure for retaining the rollable top portion in a rolled configuration with the opening and closure mechanism shielded within the rolled top portion.

18. A method of storing a contained item using a waterproof bag, the method comprising:
providing an impermeable bag comprising a horizontal waterproof closure mechanism wherein an opening permits access for placement of the contained item therein;
closing the closure mechanism to form a waterproof seal preventing passage through the opening;
rolling a rollable portion of the bag to cover the opening and the closure mechanism; and
securing the rollable portion to maintain a rolled configuration.
